(19) United States
(12) Patent Application Publication
(10) Pub. No.: US 2025/0254233 A1
(43) Pub. Date: Aug. 7, 2025

(54) SYSTEM AND METHOD FOR AN ENHANCED CONTENT MANAGEMENT SYSTEM

(71) Applicant: RAKUTEN MOBILE, INC., Tokyo (JP)

(72) Inventor: Mst Farzana KHATUN, Tokyo (JP)

(73) Assignee: RAKUTEN MOBILE, INC., Tokyo (JP)

(21) Appl. No.: 18/010,850

(22) PCT Filed: Oct. 19, 2022
(86) PCT No.: PCT/US2022/047075

§ 371 Date: Dec. 16, 2022

(51) Int. Cl. H04L 67/62; H04L 67/5682

(52) U.S. Cl. CPC H04L 67/62; H04L 67/5682

(57) ABSTRACT

A system for managing digital content, the system comprising: a memory storing instructions; at least one processor configured to execute the instructions to: receive, by a Content Management Platform, a first digital content and a second digital content; determine, by a Content Delivery Management Module and a Scheduler Module, a content type of each of the received first digital content and the received second digital content; and store, by the Content Delivery Management Module and based on the determined content type, the first digital content and the second digital content in a Content Storage.

### TECHNICAL FIELD

Systems and methods consistent with example embodiments of the present disclosure relate to a content management system, and in particular relate to a content management system for managing and scheduling release of digital content.

### BACKGROUND

In the related art, a content management system (CMS) may include a software platform having applications and computational hardware resources for managing a digital content. The related art CMS cannot differentiate between different types of digital content.

For instance, the related art CMS cannot differentiate time-sensitive digital content (i.e., digital content which need to be released on a specific time) and non-time-sensitive digital content (i.e., digital content which can be released at any time). Accordingly, in order to release a digital content, a user (e.g., a member of a user experience (UX) team, a creator of the digital content, a manager of the digital content, etc.) has to always schedule the release of the digital content, regardless of the type of the digital content. Namely, the related art CMS requires the user to always schedule the release of all digital contents, without any appropriate approach for managing digital contents depending on the user's requirement (e.g., time sensitivity of the digital content, priority of the digital content, etc.) Moreover, the related art CMS requires all user to schedule the release of digital content in a same manner, without any available approach for the users to schedule the release of digital content according to their specific requirement.

Further, as will be further described in the following, in the related art, whenever the user uploads a digital content to CMS, said digital content is always required to be stored in a temporary sub-storage before being released.

As result, the CMS in the related art has the following technical disadvantages: non-time-sensitive and/or high priority digital content cannot be released immediately without scheduling; a Content Storage (e.g., including the temporary sub-storage) requires a high capacity of computational resources to host the temporary sub-storage for storing all types of digital content; the use of network resources for managing the scheduling, for example, timing, network traffic etc., are superfluous, since a release of a certain type of digital content (e.g., non-time-sensitive digital content) does not require any scheduling (e.g., a release of time-sensitive digital content may be impeded (i.e., delayed) whenever the CMS does not have sufficient network resources for scheduling a release of time-sensitive digital content); and the user needs to manually schedule the release for any types of digital contents (e.g., if the amount of digital contents to be released is significant, this places a burden on the user to timely manage and accurately schedule the release of said digital contents, and may causes human errors during processing).

### SUMMARY

According to embodiments, systems and methods provide for an enhanced CMS for managing the creation and scheduling of digital content that enables simplified processing of digital content of a first content type (e.g., time-sensitive digital content) and digital content of a second content type (e.g., non-time-sensitive digital content). The enhanced CMS has the advantage that second type content can be released immediately without scheduling. According to the enhanced CMS, lower network storage is required (e.g., for temporarily storing only digital content of a first content type since the digital content of a second content type is not temporarily stored) and fewer network resources (e.g., time, network traffic, etc.) are utilized (e.g., no need to schedule a release of digital content of a second content type (e.g., non-time-sensitive digital content)). Moreover, the enhanced CMS eradicates potential impediments which may affect the release of digital content of a first content type (e.g., time-sensitive digital content), thereby increasing the stability of delivery of digital content of a first content type (e.g., time-sensitive digital content). Furthermore, the enhanced CMS simplifies the operation for the user (i.e., the user only need to schedule the release for digital content of a first content type (e.g., time-sensitive digital content).

According to embodiments, a system for managing digital content may comprise: a memory storing instructions; at least one processor. The at least one processor may be configured to execute the instructions to receive, by a Content Management Platform, a first digital content and a second digital content; determine, by a Content Delivery Management Module and a Scheduler Module, a content type of each of the received first digital content and the received second digital content; and store, by the Content Delivery Management Module and based on the determined content type, the first digital content and the second digital content in a Content Storage.

The first digital content may be a time-sensitive digital content, and the at least one processor may be configured to execute the instructions to store the first digital content in the Content Storage by: storing, based on determining that the first digital content is the time-sensitive digital content, the first digital content in a Temporary Sub-storage of the Content Storage.

The second digital content may be a non-time-sensitive digital content, and the at least one processor may be configured to execute the instructions to store the second digital content in the Content Storage by: storing, based on determining that the second digital content is the non-time-sensitive digital content, the second digital content in a Release Sub-storage of the Content Storage.

The at least one processor may be further configured to execute the instructions to: output, by the Scheduler Module, a user interface (UI) to a user based on determining that the first digital content is the time-sensitive digital content; and receive, by the Scheduler Module via the UI, a user input of release schedule information for the first digital content.

The at least one processor may be further configured to execute the instructions to: determine, by a Batch Executor Module, whether or not a release time for the first digital content is within a threshold; send, based on determining that the release time is within the threshold and by the Batch Executor Module, a release trigger message to the Content Delivery Management Module; and transfer, based on the release trigger message and by the Content Delivery Management Module, the first digital content from the Temporary sub-storage to a Release Sub-storage of the Content Storage.

The at least one processor may be further configured to execute the instructions to: receive, by the Scheduler Module, content status information from the Content Delivery Management Module; and output, based on the content status information and by the Scheduler Module, a user interface (UI) to a user.

The at least one processor may be further configured to execute the instructions to: receive, by the Scheduler Module via the UI, a user input for modifying a release schedule of the first digital content; generate, based on the user input and by the Scheduler Module, an updated release schedule information; provide, by the Scheduler Module, the updated release schedule information to the Batch Executor Module; generate, by the Batch Executor Module, an updated release trigger message; provide, by the Batch Executor Module, the updated release trigger message to the Content Delivery Management Module; and update, based on the updated release trigger message and by the Content Delivery Management Module, the storing of the first digital content.

According to embodiments, a method for managing digital content, performed by at least one processor, includes: receiving, by a Content Management Platform, a first digital content and a second digital content; determining, by a Content Delivery Management Module and a Scheduler Module, a content type of each of the received first digital content and the received second digital content; and storing, by the Content Delivery Management Module and based on the determined content type, the first digital content and the second digital content to a Content Storage.

The first digital content may be a time-sensitive digital content, and the storing the first digital content to the Content Storage may include: storing, based on determining that the first digital content is the time-sensitive digital content, the first digital content in a Temporary Sub-storage of the Content Storage.

The second digital content may be a non-time-sensitive digital content, and the storing the first digital content to the Content Storage may include: storing, based on determining that the second digital content is the non-time-sensitive digital content, the second digital content in a Release Sub-storage of the Content Storage.

The method may further include: outputting, by the Scheduler Module, a user interface (UI) to a user based on determining that the first digital content is the time-sensitive digital content; and receiving, by the Scheduler Module via the UI, a user input of release schedule information for the first digital content.

Further, the method may further include: determining, by a Batch Executor Module, whether or not a release time for the first digital content is within a threshold; sending, based on determining that the release time is within the threshold and by the Batch Executor Module, a release trigger message to the Content Delivery Management Module; and transferring, based on the release trigger message and by the Content Delivery Management Module, the first digital content from the Temporary sub-storage to a Release Sub-storage of the Content Storage.

Furthermore, the method may further include: receiving, by the Scheduler Module, content status information from the Content Delivery Management Module; and outputting, based on the content status information and by the Scheduler Module, a user interface (UI) to a user.

In addition, the method may further include: receiving, by the Scheduler Module via the UI, a user input for modifying a release schedule of the first digital content; generating, based on the user input and by the Scheduler Module, an updated release schedule information; providing, by the Scheduler Module, the updated release schedule information to the Batch Executor Module; generating, by the Batch Executor Module, an updated release trigger message; providing, by the Batch Executor Module, the updated release trigger message to the Content

Delivery Management Module; and updating, based on the updated release trigger message and by the Content Delivery Management Module, the storing of the first digital content.

According to embodiments, a non-transitory computer-readable recording medium having recorded thereon instructions executable by at least one processor to cause the at least one processor to perform a method for managing digital content, includes: receiving, by a Content Management Platform, a first digital content and a second digital content; determining, by a Content Delivery Management Module and a Scheduler Module, a content type of each of the received first digital content and the received second digital content; and storing, by the Content Delivery Management Module and based on the determined content type, the first digital content and the second digital content to a Content Storage.

The first digital content may be a time-sensitive digital content, and the storing the first digital content to the Content Storage may include: storing, based on determining that the first digital content is the time-sensitive digital content, the first digital content in a Temporary Sub-storage of the Content Storage.

The second digital content may be a non-time-sensitive digital content, and the storing the first digital content to the Content Storage may include: storing, based on determining that the second digital content is the non-time-sensitive digital content, the second digital content in a Release Sub-storage of the Content Storage.

The method may further include: outputting, by the Scheduler Module, a user interface (UI) to a user based on determining that the first digital content is the time-sensitive digital content; and receiving, by the Scheduler Module via the UI, a user input of release schedule information for the first digital content.

Further, the method may further include: determining, by a Batch Executor Module, whether or not a release time for the first digital content is within a threshold; sending, based on determining that the release time is within the threshold and by the Batch Executor Module, a release trigger message to the Content Delivery Management Module; and transferring, based on the release trigger message and by the Content Delivery Management Module, the first digital content from the Temporary sub-storage to a Release Sub-storage of the Content Storage.

Furthermore, the method may further include: receiving, by the Scheduler Module, content status information from the Content Delivery Management Module; and outputting, based on the content status information and by the Scheduler Module, a user interface (UI) to a user.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1A illustrates a content management system (CMS) according to the related art.

FIG. 1B illustrates a flow diagram of a content management process according to the related art CMS.

FIG. 2 illustrates an enhanced content management system (CMS), according to one or more embodiments.

FIG. 3 illustrates an example flow chart of a method for managing a digital content release in an enhanced CMS, according to one or more embodiments.

FIG. 4 illustrates an example flow chart of a method for engaging a user via an enhanced CMS, according to one or more embodiments

FIG. 5 illustrates an example flow chart of a method for determining a digital content type of a digital content, according to one or more embodiments.

FIG. 6 illustrates an example flow chart of a method for outputting a UI to a user, according to one or more embodiments

FIG. 7 illustrates another example flow chart of a method for outputting a UI to a user, according to one or more embodiments.

FIG. 8 illustrates yet another example a flow chart of a method for outputting a UI to a user after, according to one or more embodiments.

FIG. 9 illustrates an example flow chart of a method for modifying a scheduled release of a digital content, according to one or more embodiments.

FIG. 10 illustrates an example flow chart of a method for modifying a released digital content, according to one or more embodiments.

FIG. 11 is a diagram of example components of a device, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flow charts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations may include each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which a user can manage and schedule the release of a digital content by an enhanced CMS as per user's requirement. For instance, the enhanced CMS of the present disclosure enables a user to schedule the release of a first content type of digital content (e.g., time-sensitive digital contents such as seasonal greeting message and advertisement of campaign events, master-branch related digital contents, digital contents related to staging stage, etc.), while enables a second content type of digital contents (e.g., non-time sensitive contents such as update of a page design, feature-branch related digital contents, etc.) to be automatically released after the user uploaded said second content type of digital contents to the enhanced CMS.

In some embodiments, the enhanced CMS of the present disclosure enables multiple digital contents (e.g., multiple non-time-sensitive digital contents, etc.) to be released simultaneously. In some embodiments, the enhanced CMS of the present disclosure eradicates potential impediments which may affect the release of digital content of a first content type (e.g., time-sensitive digital content), thereby increasing the stability of delivery of said digital content of the first content type. The enhanced CMS further reduces the requirement for computational and network resources to process the release scheduling of digital contents and eradicates human error by simplifying the release scheduling operation.

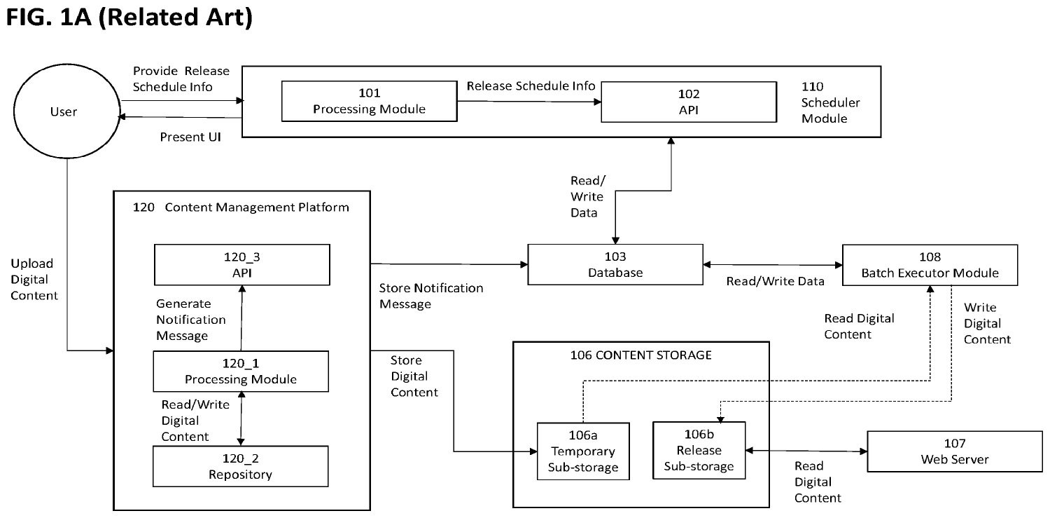

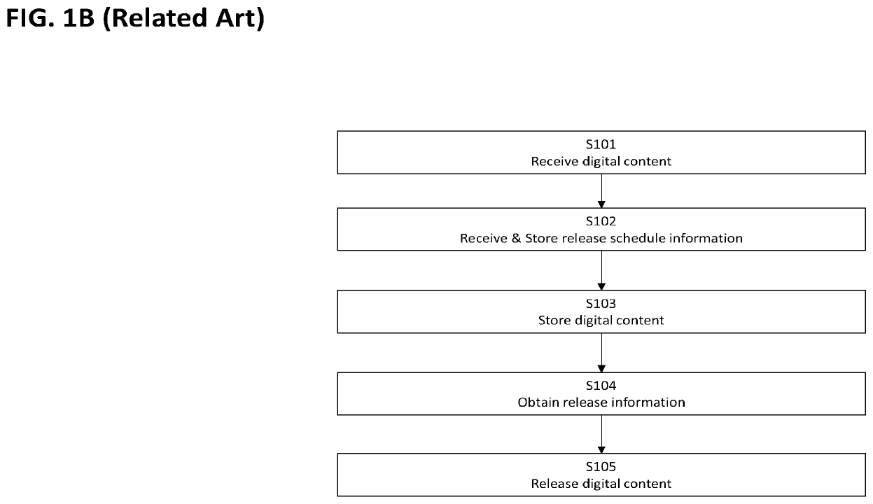

FIG. 1A illustrates a content management system (CMS) according to the related art. Referring to FIG. 1A, the CMS of the related art may include a Scheduler Module 110. The Scheduler Module 110 may be a software platform having applications and computational resources for managing the scheduling of digital content release. The Scheduler Module 110 may include a Processing Module 101 which generate a user interface (UI) to engage with a user, and an Application Programming Interface (API) 102 which communicatively couple the Processing Module 101 to a Database 103.

Moreover, the CMS in FIG. 1A may include a Content Management Platform 120. The Content Management Platform 120 may be a software platform having applications and computational resources for managing a digital content (e.g., storing of digital content, tracking changes in digital content, etc.) The Content Management Platform 120 may include a Processing Module 120_1 which performs appropriate operations and functions for managing a digital content (e.g., receiving a digital content from a user, storing the digital content in a repository, etc.), a Repository 120_2 which stores digital content provided by a user, and an API 120 3 which communicatively couple the Processing Module 120_1 to the Database 103. In some embodiments, the Content Management Platform 120 may be a distribution server platform (e.g., GitLab platform, etc.), and the Processing Module 120_1 and Repository 120_2 may be included in a distribution server repository (e.g., Git repository, etc.)

In addition, the CMS in FIG. 1A may include a Content Storage 106, a Web Server 107, and a Batch Executor Module 108. The Batch Executor Module 108 may be a software platform having applications and computational hardware resources for managing the scheduling of digital content in batch. The Batch Executor Module 108 may communicatively couple to the Database 103 and to the Content Storage 106. In particular, the Batch Executor Module 108 may periodically check the Database 103 for new release schedule information, and if the time for a digital content release is due or within a pre-set threshold (e.g., 1 minute before the scheduled digital content release, etc.), the Batch Executor Module 108 executes a content release process such that the associate digital content will be released and thus be available to other users (e.g., updating content of a webpage such that said content is viewable by customers accessing the webpage via the Web Server 107, etc.)

In some embodiments, the Content Storage 106 may include at least two sub-storages. In some embodiments, the Content Storage 106 may include a Temporary Sub-storage 106a and a Release Sub-storage 106b, each of which store digital contents at different stages. In some embodiments, the Content Storage 106 is a content object storage for storing content object of digital contents. Specifically, upon receiving a digital content from a user, the Processing Module 120_1 of Content Management Platform 120 may extract the content object (e.g., only information which are required to be published) from the digital content and provide the content object to the Temporary Sub-storage 106a for temporary storing prior to content release, while the full digital content (including functional contents like program algorithms) may be stored by the Processing Module 120_1 in the Repository 120_2 of Content Management Platform 120. In some embodiments, the Processing Module 120_1 may simply provide the full digital content to the Temporary Sub-storage 106a for temporary storing prior to content release. Subsequently, when the Batch Executor Module 108 executes a content release process, the Batch Executor Module 108 moves (e.g., copy and paste) the to-be released digital content or content object from the Temporary Sub-storage 106a to the Release Sub-storage 106b. The Release Sub-storage 106b can communicatively couple to the Web Server 107 for the publication of digital content to any suitable party (e.g., customers, subscribers, public domain, etc.) via the Web Server 107.

FIG. 1B illustrates a flow diagram of a content management process according to the related art CMS based on FIG. 1A. Referring to FIG. 1B, a user may create digital content (such as web content) and can schedule the release of said digital content to publish it via the CMS.

To this end, in step S101, a Content Management Platform 120 receives a digital content from a user. In some embodiments, the Processing Module 120_1 of Content Management Platform 120 creates a notification message and sends the notification message to a Database 103 via an API 120_3 of Content Management Platform 120. The API 102 of Scheduler Module 110 periodically checks Database 103 to obtain any notification message newly stored in the Database 103, and then provide the new notification message to the Processing Module 101 of the Scheduler Module 110.

In step S102, the Scheduler Module 101 receives information of the release schedule of the digital content from the user and stores said release schedule information in the Database 103. In some embodiments, the Processing Module 101 of the Scheduler Module 101 generates a user interface (UI) to engage with the user. In some embodiments, the UI presented to the user comprises information of the newly uploaded digital content (e.g., upload time of the digital content, size of the digital content, successful upload/failed upload, reason of failed upload, etc.), and comprises one or more interactive elements (e.g., buttons, input fields, etc.) to allow the user to schedule the release schedule of the digital content via interacting with the one or more interactive elements. For instance, the user can input information of the release schedule of the digital content (e.g., release time, release date, release period, and any suitable information for scheduling the release of the digital content.) by interacting with the associated interactive element(s) included in the UI. The Processing Module 101 receives the release schedule information via the UI and stores this release schedule information to the Database 103 via API 102.

In step S103, the Content Management Platform 120 stores the received digital content to a Content Storage 106. In some embodiments, the Processing Module 120_1 of the Content Management Platform 120 extracts the content object of the digital content and copy the content object to a Temporary Sub-storage 106a of the Content Storage 106. In some embodiments, the Processing Module 120_1 of the Content Management Platform 120 stores the received digital content to the Temporary Sub-storage 106a of the Content Storage 106. The digital content is not yet published until the associated content object or the digital content is moved from the Temporary Sub-storage 106a to a Release Sub-storage 106b of the Content Storage 106.

In step S104, the Batch Executor Module 108 obtains release schedule information from Database 103. In some embodiments, the Batch Executor Module 108 periodically check the Database 103 for new release schedule information, and obtains new release schedule information from Database 103 if any. The new release schedule information may indicate a scheduled time for a release of digital content (or the associated content object) newly stored in the Temporary Sub-storage 106a.

In step S105, the Batch Executor Module 108 releases a digital content. In some embodiments, when the time for releasing a digital content is due or within a pre-set threshold, the Batch Executor Module 108 perform an operation (e.g., S3CLI-based cut & paste process) within the Content Storage 106 to move the digital content (or the associated content object) from the Temporary Sub-storage 106a to Release Sub-storage 106b. After the digital content (or the associated content object) was moved to the Release Sub-storage 106b, the release is deemed to be completed and the digital content is successfully published. The digital content in the Release sub-storage 106b is accessible by a user (e.g., customer, subscriber, etc.) or the public domain via the Web Server 107.

As set forth above, a related art CMS manages and schedules the deployment of digital content in the same manner, irrespective of the user's requirement (e.g., regardless of the type of digital content, etc.) As a result, all digital content must be scheduled for release, and all digital content (or at least content object of all digital content) is required to be stored in a temporary sub-storage (e.g., folder or file directory) prior to release.

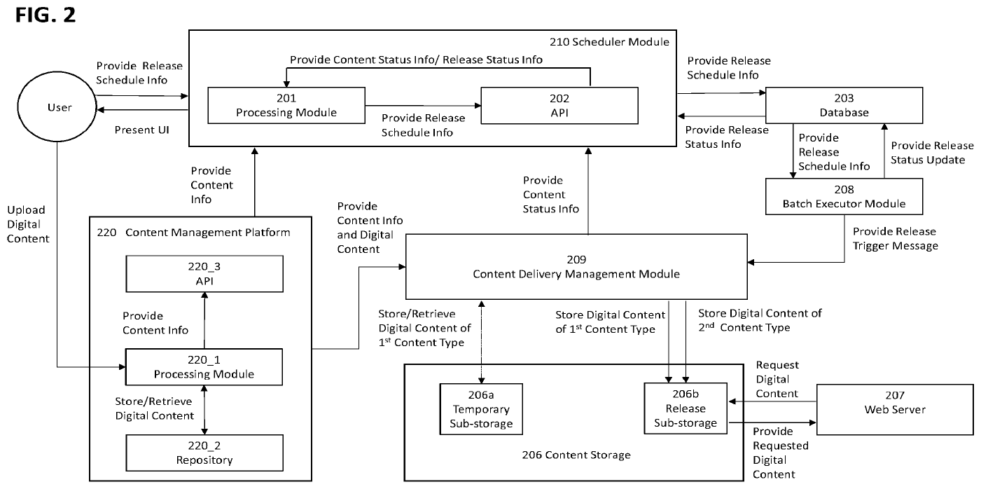

FIG. 2 illustrates an enhanced content management system (CMS) according to one or more embodiments. Referring to FIG. 2, the enhanced CMS may include a Scheduler Module 210. The Scheduler Module 210 can control the release (e.g., scheduling of a new release, rescheduling of a scheduled release, cancellation of a scheduled release, etc.) of digital content. To this end, in an example embodiment, the Scheduler Module 210 may determine which digital content require a user to schedule for release and which digital content does not require the user to schedule for release.

The Scheduler Module 210 may include a Processing Module 201 and an Application Programming Interface (API) 202. The Processing Module 201 can receive information of an uploaded digital content from a Content Management Platform 220, and determine the type of the uploaded digital content based on the received information. Subsequently, if the Processing Module 201 determines that the digital content belong to a first content type of digital content (e.g., time-sensitive digital content such as Master-branch related digital content, Staging-branch related digital content, etc.), the Processing Module 201 generates a user interface (UI) to engage a user (e.g., a member of UX team, a digital content creator, etc.) to input release schedule information for scheduling the release of the digital content and to display a status of the digital content (e.g., “upload success” or “upload failed due to Reason A”, “scheduled to be released by X”, etc.) Alternatively, if the Processing Module 201 determines that the digital content belong to a second content type of digital content (e.g., non-time-sensitive digital content, etc.), the Processing Module 201 generates a UI to simply display a status of the digital content without requiring the user to input release schedule information for scheduling the release of said digital content.

Still referring to FIG. 2, the enhanced CMS may include a Content Management Platform 220. In an example embodiment, the Content Management Platform 220 may be a software platform having applications and computational resources for managing a digital content (e.g., storing of digital content, tracking changes in digital content, managing different versions of digital content, etc.). In some embodiments, the Content Management Platform 220 may include a Processing Module 220_1, a Repository 220_2 and an API 220_3.

The Processing Module 220_1 of Content Management Platform 220 is configured to perform appropriate operations and functions for managing a digital content. In some embodiments, the Processing Module 220_1 extracts content information (e.g., commit ID, branch information, or any information suitable for identifying the type of digital content) from the uploaded digital content and provide the extracted content information to the Processing Module 201 of Scheduler Module 210 via the API 220_3. Subsequently, the Processing Module 201 determines the type of the uploaded digital content as described above. In some embodiments, the Processing Module 220_1 stores the full digital content in the Repository 220_2, extracts content object of the digital content, and provides the extracted content object and the extracted content information to a Content Delivery Management Module 209. In some embodiments, the Processing Module 220_1 stores the full digital content in the Repository 220_2 and provides the full digital content to the Content Delivery Management Module 209. In some embodiments, the Content Management Platform 220 may be a distribution server platform (e.g., GitLab platform, etc.), and the Processing Module 120_1 and Repository 220_2 may be included in a distribution server repository (e.g., Git repository, etc.)

In FIG. 2, the enhanced CMS may include a Content Storage 206, a Web Server 207, a Batch Executor Module 208, and the Content Delivery Management Module 209. The Batch Executor Module 208 can communicate with the Database 203 and with the Content Delivery Management Module 209.

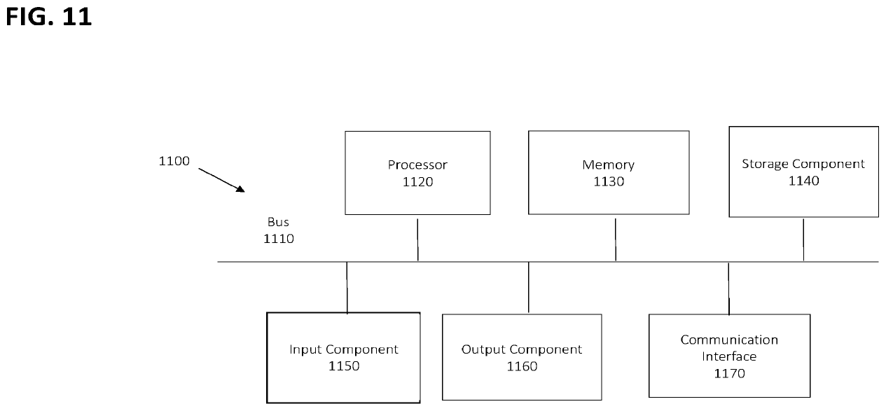

In some embodiments, the Content Delivery Management Module 209 is a software platform having applications and computational hardware resources for performing continuous integration/continuous delivery (CI/CD) operation of a digital content. In some embodiments, the Content Delivery Management Module 209 is an automation server (e.g., Jenkins, etc.) In some embodiments, the Content Delivery Management Module 209 is, for example, hosted on a device 1100 of FIG. 11. The Content Delivery Management Module 209 can connect with the Batch Executor Module 208, the Scheduler Module 210, the Content Management Platform 220, and the Content Storage 206. In some embodiments, the Content Storage 206 is a content object storage. In some embodiments, the Content Storage 206 may include a Temporary Sub-storage 206a and a Release Sub-storage 206b.

In some embodiments, the Content Delivery Management Module 209 receives the digital content (or the associated content object) and the content information from the Content Management Platform 220 (via Processing Module 220_1). Based on the content information, the Content Delivery Management Module 209 determines the type of the digital content. Subsequently, if it is determined by the Content Delivery Management Module that the digital content belongs to a first content type of content (e.g., time-sensitive digital content such as Master-branch related digital content, Staging-branch related digital content, etc.), the Content Delivery Management Module 209 stores the digital content (or the associated content object) to the Temporary Sub-storage 206a of the Content Storage 206. If it is determined that the digital content belong to a second content type of content (e.g., non-time-sensitive content object, etc.), the Content Delivery Management module 209 stores the digital content (or the associated content object) to the Release Sub-storage 206b of the Content Storage 206. That is, the digital content (or the associated content object) of the second content type is stored directly in the Release Sub-storage 206b, without being stored in the Temporary Sub-storage 206a, such that the digital content can be released and published without requiring the user to schedule the release of said digital content.

After performing an action on the digital content (or the associated content object), the Content Delivery Management Module 209 provides (via API 202) content status information to Processing Module 201 of Scheduler Module 210, and the Processing Module 201 generates a UI with updated status information of the digital content.

For instance, if the Content Delivery Management Module 209 directly store an uploaded digital content (or the associated content object) to the Release Sub-storage 206b of the Content Storage 206, the Content Delivery Management Module 209 provides a content status update to Processing Module 201 of Scheduler Module 210 (via API 202) upon completion of the storing process. Accordingly, when the user accesses the Scheduler Module 210, the Processing Module 201 generates a UI including the latest status of the uploaded digital content (e.g., “Published”, “Completed”, etc.) and presents the UI to the user.

Still referring to FIG. 2, as described in above, in case of the uploaded digital content being digital content which require release scheduling, the Processing Module 201 of Scheduler Module 210 generates a UI to engage a user to input release schedule information for scheduling the release of the digital content. In some embodiments, the UI presented to the user comprises information of the newly uploaded digital content (e.g., upload time of the digital content, size of the digital content, successful upload/failed upload, reason of failed upload, etc.), and comprises one or more interactive elements (e.g., a button, a slider, a drop-down list, an input fields, etc.) to allow the user to input (via interacting with the one or more interactive elements) the information for scheduling the release of the digital content. For instance, the user can input information of the release schedule of the digital content (e.g., release time, release date, release period, etc.) by interacting with the associated interactive element(s) in the UI. The Processing Module 201 receives the release schedule information via the UI and provide the release schedule information to the Database 203 via API 202.

The Batch Executor Module 208 can obtain new release schedule information from Database 203. The new release schedule information may indicate a scheduled time for a release of digital content (or content object) newly stored in the Temporary Sub-storage 206a. When the time for releasing a digital content is due or within a pre-set threshold, the Batch Executor Module 208 sends a release trigger message to the Content Delivery Management Module 209. In some embodiments, after sending the release trigger message, the Batch Executor Module 208 provides a release status update to the Database 203. In that case, the Database 203 can continuously or periodically generate release status information by updating the stored release schedule information and continuously or periodically provide release status information to the Processing Module 201 of Scheduler Module 210 via API 202. Subsequently, the Processing Module 201 can then generate an update UI to provide status update (e.g., “digital content scheduled to be released in X minutes”, “release of digital content in progress”, etc.) to the user.

In response to receiving the release trigger message, the Content Delivery Management Module 209 moves the digital content (or the associated content object) from the Temporary Sub-storage 206a to the Release Sub-storage 206b. After the digital content (or the associated content object) was moved to the Release Sub-storage 206b, the release of the digital content is deemed to be completed and the digital content is successfully published. The digital content in the Release Sub-storage 206b is accessible by a user (e.g., customer, subscriber, etc.) or the public domain via the Web Server 207. In some embodiment, the Content Delivery Management Module 209 continuously or periodically provide status information of the digital content to the Processing Module 201 of Scheduler Module 210 via API 202, and the Processing Module 201 can then generate an update UI to provide status update (e.g., “digital content stored in temporary sub-storage”, “digital content stored in release sub-storage”, “digital content released on X/X/2022”, etc.) to the user.

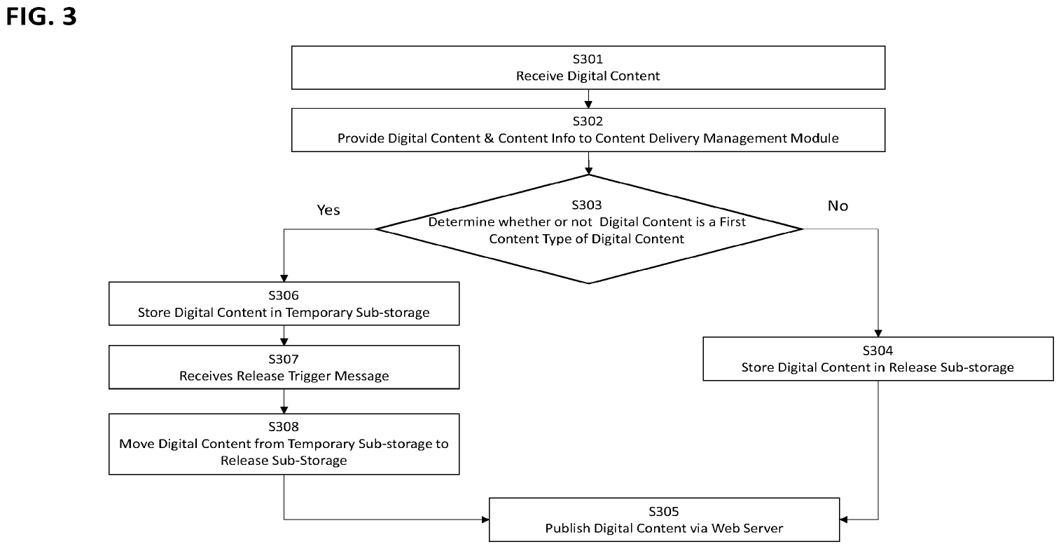

FIG. 3 illustrates an example flow chart of a method for managing a digital content release in an enhanced CMS, according to one or more embodiments.

Referring to FIG. 3, in step S301, a Content Management Platform 220 receives a digital content uploaded by a user. The digital content may include information for classifying the digital content into a first content type of the digital content (e.g., time-sensitive digital content such as Master-branch related digital content, Staging-branch related digital content, etc.) and a second content type of digital content (e.g., non-time-sensitive digital content such as Feature-branch related digital content, etc.)

In some embodiments, the classification of the digital content is based on an association of the digital content to at least one of a plurality of branches (e.g., Master-branch, Staging-branch, Production-branch, Feature-branch, etc.) in the Content Management Platform 220. For instance, the Processing Module 220_1 of Content Management Platform 220 can associate the digital content to a branch based on a predetermined policy, and a commit ID can be associated with the digital content based on the associated branch.

In an example embodiment, at least one Master-branch and at least one Feature-branch may be used for distinguishing a first content type of digital content (e.g., time-sensitive digital content) and a second content type of digital content (e.g., non-time-sensitive digital content). The Master-branch and Feature-branch may include respective branch information (e.g., branch name, branch ID, etc.) and can be defined by said branch information.

Accordingly, the first content type of digital content (e.g. time-sensitive digital content) can be associated with one or more Master-branches. A Master-branch may include only digital content of a first content type (e.g., time-sensitive digital content). In an example embodiment, digital content of a first content type (e.g., time-sensitive digital content) may be committed based on additional criteria to different Master-branches (MB1, . . . , MBn). In the enhanced CMS of FIG. 2, the branch information of said at least one Master-branch is associated with the digital content of a first content type (e.g., time-sensitive digital content), and therefore, the enhanced CMS can process said digital content in a type-based (e.g., a time-sensitive) manner. It can be understood that Master-branch is merely an example of possible branch, and the first content type of digital content can be associated to any suitable types of branches (e.g., Staging-branch, branch customized by a user, etc.) as per requirement.

Similarly, the second content type of digital content (e.g., non-time-sensitive digital content) can be associated with one or more Feature-branches. In an example embodiment, digital content of a second content type (e.g., non-time-sensitive digital content) may be committed based on additional criteria to different Feature-branches (FB1, . . . , FBn). In the enhanced CMS of FIG. 2, the branch information of said at least one Feature-branch is associated with digital content of a second content type (e.g., non-time-sensitive digital content), and therefore the enhanced CMS can process said digital content in a type-based (e.g. non-time-sensitive) manner. It can be understood that Feature-branch is merely an example of possible branch, and the second content type of digital content can be associated with any suitable types of branches as per requirement.

Referring still to FIG. 3, in step S302, the Content Management Platform 220 provides the digital content and content information to a Content Delivery Management Module 209. In some embodiments, Processing Module 220_1 of the Content Management Platform 220 obtains content information (e.g., commit ID, branch information, or any information suitable for identifying the type of content) from the uploaded digital content and provides the content information along with the digital content to the Content Delivery Management Module 209. In some embodiments, the Processing Module 220_1 of the Content Management Platform 220 extracts a content object of the digital content and provides the content object and the content information to the Content Delivery Management Module 209.

In step S303, Content Delivery Management Module 209 determines, based on the content information, whether or not the digital content (or the associated content object) is a first content type of digital content. In some embodiments, the Content Delivery Management Module 209 may determine the type of the digital content by determining (from the content information) the branch information of the digital content. For instance, the Content Delivery Management Module 209 may determine, based on the content information (e.g., commit ID, branch ID, or any information suitable for identifying the type of content), a branch associated with the digital content, and determines whether or not the branch is associated with a first content type of digital content (e.g., time-sensitive digital content) or is associated with a second content type of digital content (e.g., non-time-sensitive digital content).

In step S304, based on determining that the digital content is a second content type (“No” at S303), the Content Delivery Management Module 209 directly stores the digital content (or the associated content object) into a Release Sub-storage 206b of Content Storage 206, without storing the digital content (or the associated content object) into a Temporary Sub-storage 206a of the Content Storage 206, such that the digital content can be released and published without requiring the user to schedule the release of said digital content.

In step S305, the digital content is released and published via Web Server 207. In an example embodiment, a user (e.g., customer, subscriber, etc.) accesses Web Server 207 to view the published digital content. Subsequently, Web Server 207 sends to Content Storage 206 a request for retrieving a digital content (or the associated content object) stored in Release Sub-storage 206b, and in response, Release Sub-storage 206b of Content Storage 206 provides the requested digital content (or the associated content object) to the Web Server 207. Accordingly, the user is able to view the published digital content via the Web Server 207.

Conversely, in step S306, based on determining that the digital content is a first content type (“Yes” at S303), the Content Delivery Management Module 209 stores the digital content (or the associated content object) to the Temporary Sub-storage 206a of Content Storage 206 (i.e., the digital content of a second content type is not directly released).

In step S307, the Content Delivery Management Module 209 receives a release trigger message from a Batch Executor Module 208. In some embodiments, the Batch Executor Module 208 checks (e.g., polls periodically or in response to an event) the Database 203 for new release schedule information. If there is any new release schedule information stored in the Database 203, the Batch Executor Module 208 retrieves said new release schedule information from the Database 203. In case the new release schedule information indicates that a digital content is due for release (i.e., in case a scheduled time for deployment indicated in the release information has been reached or is within a predetermined time threshold (e.g., within 10 seconds of the scheduled release time)), the Batch Executor Module 208 sends the release trigger message to the Content Delivery Management Module 209. The release trigger message may simply be a notification to the Content Delivery Management Module 209 and/or may include additional release information (e.g., a release time, a release date, etc.)

In step S308, based on the received release trigger message, the Content Delivery Management Module 209 moves the digital content (or the associated content object) from the Temporary Sub-storage 206a to the Release Sub-storage 206b. For example, the Content Delivery Management Module 209 is configured to transfer or move the digital content from the Temporary Sub-storage 206a to the Release Sub-storage 206b for publication. Accordingly, the process proceeds to step S305, in which a user (e.g., customer, subscriber, etc.) accesses Web Server 207 to view the published digital content as described above.

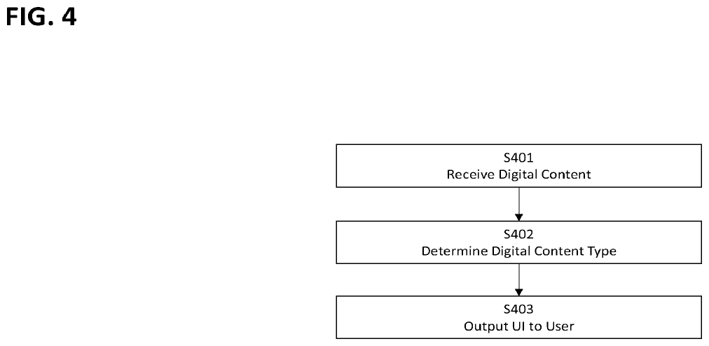

FIG. 4 illustrates an example flow chart of a method for engaging a user via an enhanced CMS, according to one or more embodiments.

Referring to FIG. 4, in step S401 (similar to step S301 in FIG. 3), the Content Management Platform 220 receives a digital content uploaded by a user.

In step S402, the Processing Module 201 of Scheduler Module 210 determines a digital content type of the digital content. In some embodiments, the Processing Module 201 determines whether the uploaded digital content is a first content type of digital content (e.g., time-sensitive digital content) or a second content type of digital content (e.g., non-time-sensitive digital content).

In step S403, the Processing Module 201 generates, based on the determined digital content type, a User Interface (UI) and present the generated UI to the user.

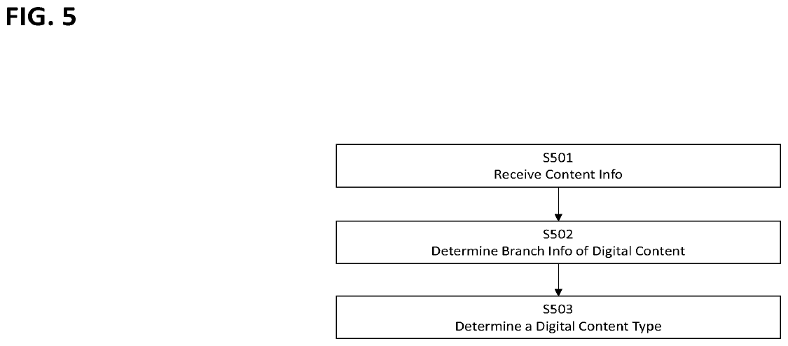

FIG. 5 illustrates an example flow chart of a method for determining a digital content type of a digital content, according to one or more embodiments. The method of FIG. 5 may correspond to step S402 in FIG. 4, and may be performed by the Processing Module 201 of Scheduler Module 210, according to one or more embodiments.

Referring to FIG. 5, in step S501, the Processing Module 201 receives, from the Content Management Platform 220, content information of the uploaded digital content. In some embodiments, the content information comprises commit ID, branch information, and any other suitable information for determining the digital content type of the digital content. In some embodiments, the content information is provided to the Processing Module 201 via API 220_3 of the Content Management Platform 220.

In step S502, the Processing Module 201 determines a branch information of the digital content. In some embodiments, the Processing Module 201 may determine the branch information from the content information, wherein the branch information comprises a branch type (e.g., Master-branch, Staging-branch, Feature-branch, etc.) associated with the digital content, and a digital content type (e.g., a first content type such as time-sensitive content, a second content type of digital content such as non-time-sensitive content, etc.) associated with the branch type.

In step S503, the Processing Module 201 determines a digital content type of the digital content. In some embodiments, the Processing Module 201 may determine the digital content type of the digital content based on the branch information determined in step S502. In an example embodiment, the Processing Module 201 may determine that the digital content is a first content type of digital content, based on determining that the digital content has a branch type of “Master-branch” and the “Master-branch” is associate with a first content type.

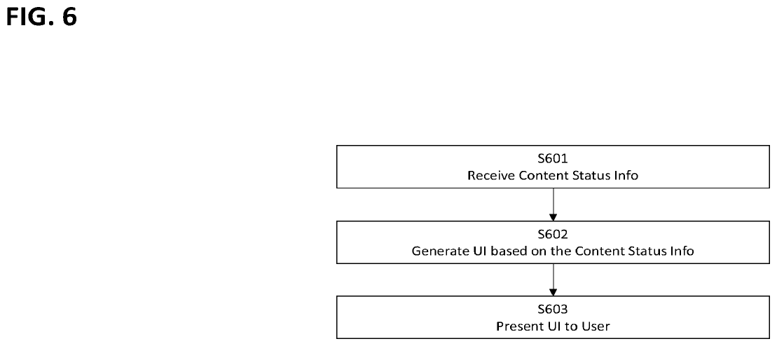

FIG. 6 illustrates an example flow chart of a method for outputting a UI to a user, according to one or more embodiments. In some embodiments, the UI is outputted to the user based on determining that the digital content has a digital content type other than the first digital content type (e.g., the digital content type is a second content type of digital content such as a non-time-sensitive digital content, etc.). The method of FIG. 6 may correspond to step S403 in FIG. 4, and may be performed by the Processing Module 201 of Scheduler Module 210, according to one or more embodiments.

Referring to FIG. 6, in step S601, the Processing Module 201 receives (from the Content Delivery Management Module 209) content status information of a digital content. The content status information comprises the status of storing digital content in the Content Storage 206 (e.g., “Storing in progress”, “Storing failed”, “Stored successfully in Release Sub-storage on 1:00 PM”, etc.) Further, the content status information may comprise part of or all of content information (e.g., commit ID, branch information, content file size, name of content creator, etc.) as discussed above in relation to FIG. 5.

In step S602, the Processing Module 201 generates a UI based on the content status information and the content information. To this end, since the digital content is not a first content type of digital content, said digital content is stored directly to a Release Sub-storage 206b. Accordingly, in some embodiments, the Processing Module 201 may determine, from the content status information, a release status of the digital content (e.g., “released completed”, “released on x/x/2022”, etc.) In addition to the content information (e.g., commit ID, branch information, content file size, etc.) and storing information (e.g., “Stored successfully in Release Sub-storage on 1:00 PM”, etc.), the Processing Module 201 may include said release status in the UI during generation of the UI.

In step S603, the Processing Module 201 presents the generated UI to the user. In some embodiments, the Processing Module 201 continuously or periodically obtain new content status information from the Content Delivery Management Module 209, continuously or periodically generate an updated UI based on the new content status information, and continuously or periodically present the updated UI to the user. In this way, the Processing Module 201 may provide a dynamic status presentation to the user, in which the user can be notified about the latest status of the digital content.

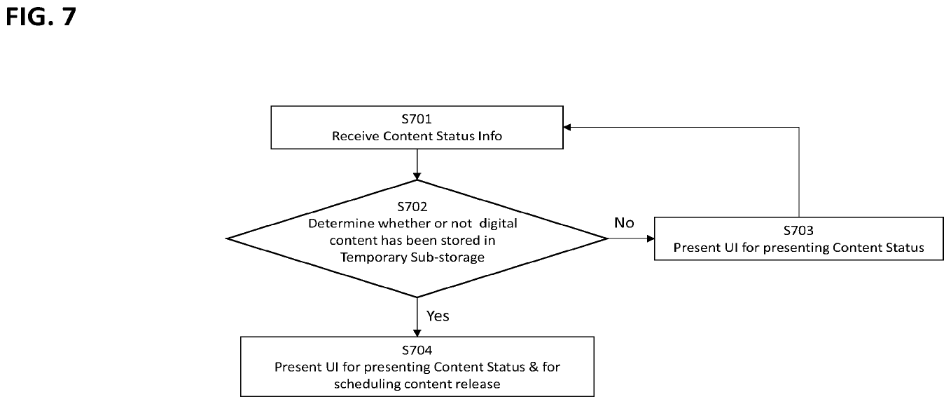

FIG. 7 illustrates another example flow chart of a method for outputting a UI to a user, according to one or more embodiments. In some embodiments, the UI is outputted to the user based on determining that the digital content is a first digital content type of digital content (e.g., a time-sensitive digital content, etc.) The method of FIG. 7 may correspond to step S403 in FIG. 4, and may be performed by the Processing Module 201 of Scheduler Module 210 according to one or more embodiments.

Referring to FIG. 7, in step S701 (similar to step S601 in FIG. 6), the Processing Module 201 receives, from the Content Delivery Management Module 209, content status information of a digital content. The content status information comprises the status of storing digital content in the Content Storage 206 (e.g., “Storing in progress”, “Storing failed”, “Stored successfully in Temporary Sub-storage on 2:00 PM”, etc.) Further, the content status information may comprise part of or all of content information (e.g., commit ID, branch information, content file size, name of content creator, etc.) as discussed above in relation to FIG. 5.

In step S702, the Processing Module 201 determines, based on the content status information, whether or not the digital content (or the associated content object) has been stored successfully or completely in the Temporary Sub-storage 206a of Content Storage 206.

In Step S703, based on determining that the digital content has not yet being stored successfully or completely in Temporary Sub-storage 206a (“No” in step S702), the Processing Module 201 generates and presents a UI comprises only storing status of the digital content (e.g., “Storing in progress”, “Storing failed due to reason X”, etc.) and content information (e.g., commit ID, branch information, content file size, name of content creator, etc.), without including interactive elements (e.g., button, slider, input field, etc.) that allows the user to schedule the release of the digital content. Subsequently, the process returns to steps S701-S702.

In step S704, based on determining that the digital content has been stored successfully or completely in Temporary Sub-storage 206a (“Yes” in step S702), the Processing Module 201 generates and presents a UI comprises one or more interactive elements (e.g., button, slider, input field, etc.) that allows the user to schedule the release of the digital content, in addition to the storing status of the digital content and the content information. In an example embodiment, the Processing Module 201 generates, based on the user's interaction with the one or more interactive elements in the UI, a release schedule information comprises a release time, a release date, a release period, and any suitable information for defining the scheduling of the release of the digital content. Accordingly, the Processing Module 201 stores the release schedule information in a Database 203 (e.g., via API 202).

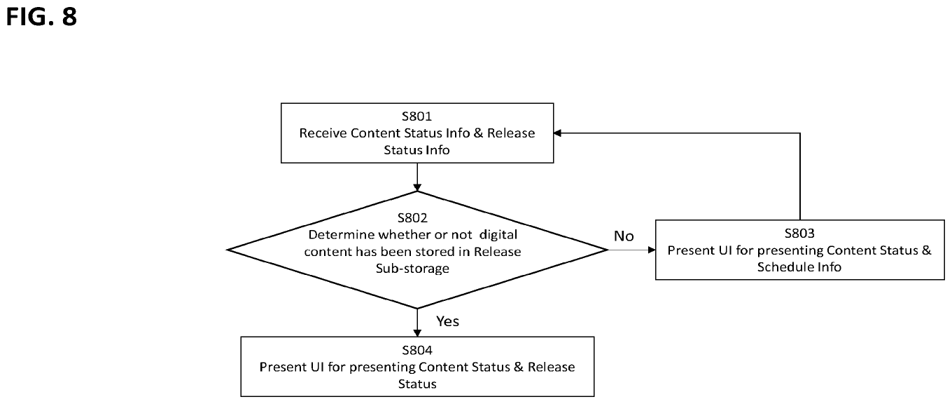

FIG. 8 illustrates yet another example a flow chart of a method for outputting a UI to a user, according to one or more embodiments. In some embodiments, the UI is outputted to the user after a release for a digital content is scheduled. The method of FIG. 8 may be performed subsequent to step S704 in FIG. 7, and may be performed by the Processing Module 201 of Scheduler Module 210 according to one or more embodiments.

Referring to FIG. 8, in step S801, the Processing Module 201 receives content status information from Content Delivery Management Module 209 and receives release status information from Database 203. In some embodiments, API 202 of Scheduler Module 210 continuously or periodically query the Database 203, so as to continuously or periodically request for the release status information. The content of the content status information and the content of the release status information were described above in relation to FIG. 2-FIG. 7, thus detailed descriptions of the content of said information are omitted herein for the purpose of brevity.

In step S802, the Processing Module 201 determines the storing status of the digital content. Specifically, the Processing Module 201 determines, based on the content status information, whether or not the digital content (or the associated content object) has been stored successfully or completely in the Release Sub-storage 206b of Content Storage 206.

In step S803, based on determining that the digital content has not yet being stored successfully or completely in Release Sub-storage 206b (“No” in step S802), the Processing Module 201 generates and presents a UI comprises storing status of the digital content and the content information, as described above in relation to FIG. 7. Further, the Processing Module 201 determines, based on the release status information, that the time for a digital content release is within a pre-set threshold (e.g., 5 minutes form the scheduled digital content release, etc.), the Processing Module 201 generates the UI to include one or more interactive elements (e.g., button, slider, input field, etc.) that allows the user to modify the scheduled release of the digital content (e.g., delay the scheduled release, advance the scheduled release, cancel the scheduled release, etc.) Subsequently, the process returns to steps S801-S802.

In step S804, based on determining that the digital content has been stored successfully or completely in Release Sub-storage 206b (“Yes” in step S802), the Processing Module 201 generates and presents a UI comprises storing status of the digital content, the content information, and the release status of the digital content, as described above in relation to FIG. 6-FIG. 7. In some embodiments, the UI may further comprise one or more interactive elements (e.g., button, input field, etc.) to allow a user to modify the publication of a released digital content (e.g., retract/remove the released digital content, extend the publication period of a digital content, shorten the publication period of a digital content, update a version of a released digital content, etc.)

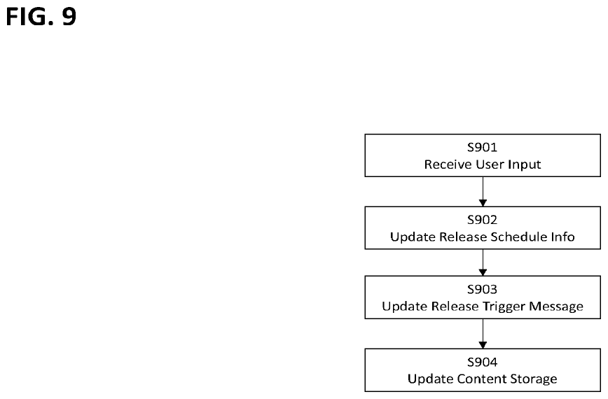

FIG. 9 illustrates an example flow chart of a method for modifying a scheduled release of a digital content, according to one or more embodiments. The method of FIG. 9 may be performed subsequent to step S803 in FIG. 8.

Referring to FIG. 9, in step S901, Processing Module 201 of Scheduler Module 210 receives a user input to modify a scheduled release for a digital content. In some embodiments, the user input is received via a UI presented to the user, wherein the user can input the desired modification (e.g., delay the scheduled release, advance the scheduled release, cancel the scheduled release, etc.) by interacting with one or more interactive elements (e.g., button, slider, input field, etc.) included in the UI.

In step S902, Processing Module 201 updates the release schedule information associated with the digital content. In some embodiments, the Processing Module 201 generates an updated release schedule information based on the user input, and provides (via API 202) the updated release schedule information to Batch Executor Module 208. In some embodiments, the Processing Module 201 provides the updated release schedule information to Database 203, and subsequently Database 203 updates (e.g., replace, etc.) the stored release schedule information with the updated release schedule information and provides the updated release schedule information to Batch Executor Module 208 (e.g., in the subsequent cycle of periodic polls from Batch Executor Module 208).

In step S903, the Batch Executor Module 208 updates the release trigger message associated to the digital content. In some embodiments, the Batch Executor Module 208 determines (based on the updated release schedule information) a type of scheduled release modification, and generates an updated release trigger message based on the type of scheduled release modification. Subsequently, the updated release trigger message is provided to the Content Delivery Management Module 209.

In step S904, the Content Delivery Management Module 209 updates the storage of the digital content (or the associated content storage) in the Content Storage 206.

Still referring to step S904, in an example embodiment, the Content Delivery Management Module 209 determines, from the updated release trigger message, that the release of the digital content is advanced and the digital content need to be released urgently (e.g., the new scheduled release is within a predetermined time threshold (e.g., within X minutes from a current time), etc.), and the Content Delivery Management 209 may thus prioritize the release of the digital content (by spending more resources to move the digital content or the associated content object from Temporary Sub-storage 206a to Release Sub-storage 206b, etc.) Conversely, if the Content Delivery Management Module 209 determines (from the updated release trigger message) that the release of the digital content is postponed and the release of the digital content is less urgent as compared to previously scheduled release, the Content Delivery Management 209 may prioritize the release of other digital contents which have a higher urgency.

Still referring to step S904, in another example embodiment, the Content Delivery Management Module 209 determines, from the updated release trigger message, that the release of the digital content is cancelled. Accordingly, the Content Delivery Management Module 209 will not move the digital content (or the associated content object) from the Temporary Sub-storage 206a to Release Sub-storage 206b (if the process of content release has not yet started), or will stop moving the digital content (or the associated content object) from the Temporary Sub-storage 206a to Release Sub-storage 206b (if the process of content release is in progress). In some embodiments, the Content Delivery Management Module 209 determines that the release of the digital content has been cancelled for a predetermined time threshold (e.g., release of digital content has been cancelled 30 days ago) and there is no further action on the release of said digital content (e.g., no new release is scheduled for the digital content since the cancellation of previously scheduled release), the Content Delivery Management Module 209 may compress the digital content (or the associated content object) stored in the Temporary Sub-storage 206a, so as to optimize the resources of Temporary Sub-storage 206a.

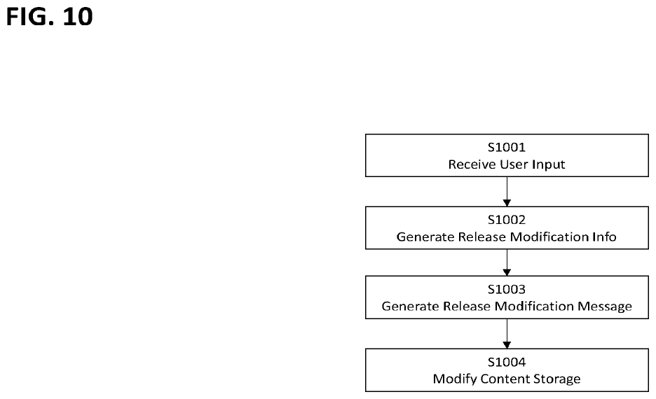

FIG. 10 illustrates an example flow chart of a method for modifying a released digital content, according to one or more embodiments. The method of FIG. 8 may be performed subsequent to step S804 in FIG. 8.

Referring to FIG. 10, in step S1001, Processing Module 201 of Scheduler Module 210 receives a user input to modify a released digital content. In some embodiments, the user input is received via a UI presented to the user, wherein the user can input the desired modification (e.g., extend the publication period of a digital content, shorten the publication period of a digital content, update a version of a released digital content, etc.) by interacting with one or more interactive elements (e.g., button, slider, input field, etc.) included in the UI.

In step S1002, Processing Module 201 generates a release modification information. In some embodiments, the Processing Module 201 generates the release modification information based on the user input, wherein the release modification information comprises information for modifying the released digital content (e.g., extend the publication period of the release digital content for another 1 month, etc.) Subsequently, the Processing Module 201 provides (via API 202) the release modification information to Database 203 to store said release modification information in the Database 203. Subsequently, Database 203 provides the release modification information to Batch Executor Module 208.

In step S1003, the Batch Executor Module 208 generates a release modification message associated with the released digital content. In some embodiments, the Batch Executor Module 208 determines (based on the updated release modification information) a type of released digital content modification, and generates an updated release modification message based on the type of released digital content modification. Subsequently, the updated release modification message is provided to the Content Delivery Management Module 209. The release modification message may simply be a notification to the Content Delivery Management Module 209 and/or may include additional release modification information (e.g., a modification time, a modification date, etc.)

In step S1004, the Content Delivery Management Module 209 updates the digital content (or the associated content storage) stored in the Content Storage 206, based on the updated release modification message. In an example embodiment, the Content Delivery Management

Module 209 determines, from the updated release modification message, that the publication of the released digital content should be extended. Accordingly, the Content Delivery Management Module 209 will extend the period of time for storing the released digital content in the Release Sub-storage 206b.

It is apparent that other suitable modification processes may also be implemented in a similar manner based on the descriptions provided herein. For instance, the system and methods described herein (e.g., FIG. 2 to FIG. 10) may be utilized to update a published digital content. In one example embodiment, the user may opt to update the published digital content (i.e., the digital content stored in the Released Sub-storage) with another digital content stored in the Temporary Sub-storage. For instance, the Scheduler Module 210 may present to the user a UI comprising information of a plurality of digital contents stored in the Temporary Sub-storage 206a (e.g., “published”, “unpublished”, etc.) and one or more interactive elements (e.g., a button, an input field, etc.), and the user may interact with the one or more interactive elements to select a digital content among the plurality of digital contents stored in the Temporary Sub-storage 206a and to schedule the release of the selected digital content.

Accordingly, the Scheduler Module 210 provides a release schedule information for the selected digital content to Database 203, Database 203 provides said release schedule information to Batch Executor Module 208, and Batch Executor Module 208 provides a release trigger message to the Content Delivery Management Module 209, in the similar manner as described herein above. Subsequently, Content Delivery Management Module 209 moves the selected digital content (or the associated content object) from Temporary Sub-storage 206a to Release Sub-storage 206b, to thereby replace the published digital content (or the associated content object) with the selected digital content (or the associated content object). To this end, the previously published digital content is updated with the user's selected digital content, and the user's selected digital content is published via Web Server 207.

FIG. 11 is a diagram of example components of a device. The device 1100 may correspond to a module and/or modules described above in relation to FIG. 2 to FIG. 10, hosted by the device 1100. As shown in FIG. 11, device 1100 may include a bus 1110, a processor 1120, a memory 1130, a storage component 1140, an input component 1150, an output component 1160, and a communication interface 1170.

Bus 1110 may include a component that permits communication among the components of device 1100. Processor 1120 may be implemented in hardware, firmware, or a combination of hardware and software. Processor 1120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1120 may include one or more processors capable of being programmed to perform a function (e.g., to perform one or more steps described above in relation to FIG. 3 to FIG. 10, etc.) Memory 1130 may include a random access memory (RAM), a read only memory (ROM), and/or another type of dynamic or static storage device (e.g., a flash memory, a magnetic memory, and/or an optical memory) that stores information and/or instructions for use by processor 1120.

Storage component 1140 stores information and/or software related to the operation and use of device 1100. For example, storage component 1140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1150 may include a component that permits device 1100 to receive information, such as via user input (e.g., a touch screen display, a keyboard, a keypad, a mouse, a button, a switch, and/or a microphone). Additionally, or alternatively, input component 1150 may include a sensor for sensing information (e.g., a global positioning system (GPS) component, an accelerometer, a gyroscope, and/or an actuator). Output component 1160 may include a component that provides output information from device 1100 (e.g., a display, a speaker, and/or one or more light-emitting diodes (LEDs)).

Communication interface 1170 may include a transceiver-like component (e.g., a transceiver and/or a separate receiver and transmitter) that enables device 1100 to communicate with other devices, such as via a wired connection, a wireless connection, or a combination of wired and wireless connections. Communication interface 1170 may permit device 1100 to receive information from another device and/or provide information to another device. For example, communication interface 1170 may include an Ethernet interface, an optical interface, a coaxial interface, an infrared interface, a radio frequency (RF) interface, a universal serial bus (USB) interface, a Wi-Fi interface, a cellular network interface, or the like.

Device 1100 may perform one or more processes described herein. Device 1100 may perform these processes in response to processor 1120 executing software instructions stored by a non-transitory computer-readable medium, such as memory 1130 and/or storage component 1140. A computer-readable medium is defined herein as a non-transitory memory device. A memory device may include memory space within a single physical storage device or memory space spread across multiple physical storage devices.

Software instructions may be read into memory 1130 and/or storage component 1140 from another computer-readable medium or from another device via communication interface 1170. When executed, software instructions stored in memory 1130 and/or storage component 1140 may cause processor 1120 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 11 are provided as an example. In practice, device 1100 may include additional components, fewer components, different components, or differently arranged components than those shown in FIG. 11. Additionally, or alternatively, a set of components (e.g., one or more components) of device 1100 may perform one or more functions described as being performed by another set of components of device 1100.

In embodiments, any one of the operations or processes of FIG. 2 to FIG. 10 may be implemented by or using any one of the elements illustrated in FIG. 11.

As set forth above, the enhanced CMS in accordance with one or more example embodiments requires no manual scheduling of deployment (release) for all digital contents Instead, the enhanced CMS according to the one or more embodiments distinguishes between digital content of a first content type (e.g., time-sensitive digital content) or digital content of a second content type (e.g., non-time-sensitive digital content), and performs scheduling with respect to only the digital content of a first content type (e.g., time-sensitive digital content). The digital content of a second content type (e.g., non-time-sensitive digital content) can therefore be processed and published more expeditiously and with resources optimization (e.g., reduce storage requirements in Temporary Sub-storage since only a particular type of digital content is required to be stored in Temporary Sub-storage, reduce the computing resources for moving the digital contents among Temporary Sub-storage and Release Sub-storage, etc.) Further, the enhanced CMS in accordance with one or more example embodiments improves user's convenience and user's experience in managing digital content. The enhanced CMS provide flexibility to a user to schedule a content release, to modify a scheduled content release, and to modify a released digital content, according to the user's requirement.

According to one or more example embodiments, the systems and methods for managing the creation and scheduling of digital content provide an enhanced CMS which have following technical advantages: a specific type of digital content can be released immediately without scheduling; a reduced network storage requirement for the content object storage to release the digital content since it is required to have less temporary storage for storing only digital content of a first content type (e.g., time-sensitive digital content); a reduction of redundant use of network resources (time, network traffic, etc.), since CMS users do not need to schedule releases of all digital contents; a remove potential factor(s) which may affect the release of digital content of a specific content types (e.g., time-sensitive digital content), thereby increase the stability and efficiency of delivery of digital contents; reduction of the burden of the user in managing digital content release, since the user only need to schedule the release for digital content of a specific content type (e.g., time-sensitive digital content).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction release device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium may include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow chart and/or block diagram block or blocks.

The flow chart and block diagrams in the Figures illustrate the architecture, functionality, and operation of possible implementations of systems, methods, and computer readable media according to various embodiments. In this regard, each block in the flow chart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flow chart illustration, and combinations of blocks in the block diagrams and/or flow chart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system for managing digital content, the system comprising:
a memory storing instructions;
at least one processor configured to execute the instructions to:
receive, by a Content Management Platform, a first digital content and a second digital content;
determine, by a Content Delivery Management Module and a Scheduler Module, a content type of each of the received first digital content and the received second digital content; and
store, by the Content Delivery Management Module and based on the determined content type, the first digital content and the second digital content in a Content Storage.

2. The system as claimed in claim 1, wherein the first digital content is a time-sensitive digital content, wherein the at least one processor is configured to execute the instructions to store the first digital content in the Content Storage by:
storing, based on determining that the first digital content is the time-sensitive digital content, the first digital content in a Temporary Sub-storage of the Content Storage.

3. The system as claimed in claim 1, wherein the second digital content is a non-time-sensitive digital content, wherein the at least one processor is configured to execute the instructions to store the second digital content in the Content Storage by:
storing, based on the determining that the second digital content is the non-time-sensitive digital content, the second digital content in a Release Sub-storage of the Content Storage.

4. The system as claimed in claim 2, wherein the at least one processor is further configured to execute the instructions to:
output, by the Scheduler Module, a user interface (UI) to a user based on determining that the first digital content is the time-sensitive digital content; and
receive, by the Scheduler Module via the UI, a user input of release schedule information for the first digital content.

5. The system as claimed in claim 2, wherein the at least one processor is further configured to execute the instructions to:
determine, by a Batch Executor Module, whether or not a release time for the first digital content is within a threshold;
send, based on determining that the release time is within the threshold and by the Batch Executor Module, a release trigger message to the Content Delivery Management Module; and
transfer, based on the release trigger message and by the Content Delivery Management Module, the first digital content from the Temporary sub-storage to a Release Sub-storage of the Content Storage.

6. The system as claimed in claim 5, wherein the at least one processor is further configured to execute the instructions to:
receive, by the Scheduler Module, content status information from the Content Delivery Management Module; and
output, based on the content status information and by the Scheduler Module, a user interface (UI) to a user.

7. The system as claimed in claim 4, wherein the at least one processor is further configured to execute the instructions to:
receive, by the Scheduler Module via the UI, a user input for modifying a release schedule of the first digital content;
generate, based on the user input and by the Scheduler Module, an updated release schedule information;
provide, by the Scheduler Module, the updated release schedule information to the Batch Executor Module;
generate, by the Batch Executor Module, an updated release trigger message;
provide, by the Batch Executor Module, the updated release trigger message to the Content Delivery Management Module; and
update, based on the updated release trigger message and by the Content Delivery Management Module, the storing of the first digital content.

8. A method for managing digital content, performed by at least one processor, the method comprising:
receiving, by a Content Management Platform, a first digital content and a second digital content;
determining, by a Content Delivery Management Module and a Scheduler Module, a content type of each of the received first digital content and the received second digital content; and
storing, by the Content Delivery Management Module and based on the determined content type, the first digital content and the second digital content to a Content Storage.

9. The method as claimed in claim 8, wherein the first digital content is a time-sensitive digital content, wherein the storing the first digital content to the Content Storage comprising:
storing, based on determining that the first digital content is the time-sensitive digital content, the first digital content in a Temporary Sub-storage of the Content Storage.

10. The method as claimed in claim 8, wherein the second digital content is a non-time-sensitive digital content, wherein the storing the first digital content to the Content Storage comprising:
storing, based on determining that the second digital content is the non-time-sensitive digital content, the second digital content in a Release Sub-storage of the Content Storage.

11. The method as claimed in claim 9, further comprising:
outputting, by the Scheduler Module, a user interface (UI) to a user based on determining that the first digital content is the time-sensitive digital content; and
receiving, by the Scheduler Module via the UI, a user input of release schedule information for the first digital content.

12. The method as claimed in claim 9, further comprising:
determining, by a Batch Executor Module, whether or not a release time for the first digital content is within a threshold;
sending, based on determining that the release time is within the threshold and by the Batch Executor Module, a release trigger message to the Content Delivery Management Module; and
transferring, based on the release trigger message and by the Content Delivery Management Module, the first digital content from the Temporary sub-storage to a Release Sub-storage of the Content Storage.

13. The method as claimed in claim 12, further comprising:
receiving, by the Scheduler Module, content status information from the Content Delivery Management Module; and
outputting, based on the content status information and by the Scheduler Module, a user interface (UI) to a user.

14. The method as claimed in claim 11, further comprising:
receiving, by the Scheduler Module via the UI, a user input for modifying a release schedule of the first digital content;
generating, based on the user input and by the Scheduler Module, an updated release schedule information;
providing, by the Scheduler Module, the updated release schedule information to the Batch Executor Module;
generating, by the Batch Executor Module, an updated release trigger message;
providing, by the Batch Executor Module, the updated release trigger message to the Content Delivery Management Module; and
updating, based on the updated release trigger message and by the Content Delivery Management Module, the storing of the first digital content.

15. A non-transitory computer-readable recording medium having recorded thereon instructions executable by at least one processor to cause the at least one processor to perform a method for managing digital content, the method comprising:
receiving, by a Content Management Platform, a first digital content and a second digital content;
determining, by a Content Delivery Management Module and a Scheduler Module, a content type of each of the received first digital content and the received second digital content; and
storing, by the Content Delivery Management Module and based on the determined content type, the first digital content and the second digital content to a Content Storage.

16. The non-transitory computer-readable recording medium as claimed in claim 15, wherein the first digital content is a time-sensitive digital content, wherein the storing the first digital content to the Content Storage comprising:
storing, based on determining that the first digital content is the time-sensitive digital content, the first digital content in a Temporary Sub-storage of the Content Storage.

17. The non-transitory computer-readable recording medium as claimed in claim 15, wherein the second digital content is a non-time-sensitive digital content, wherein the storing the first digital content to the Content Storage comprising:
storing, based on determining that the second digital content is the non-time-sensitive digital content, the second digital content in a Release Sub-storage of the Content Storage.

18. The non-transitory computer-readable recording medium as claimed in claim 16, wherein the method further comprising:
outputting, by the Scheduler Module, a user interface (UI) to a user based on determining that the first digital content is the time-sensitive digital content; and
receiving, by the Scheduler Module via the UI, a user input of release schedule information for the first digital content.

19. The non-transitory computer-readable recording medium as claimed in claim 16, wherein the method further comprising:
determining, by a Batch Executor Module, whether or not a release time for the first digital content is within a threshold;
sending, based on determining that the release time is within the threshold and by the Batch Executor Module, a release trigger message to the Content Delivery Management Module; and
transferring, based on the release trigger message and by the Content Delivery Management Module, the first digital content from the Temporary sub-storage to a Release Sub-storage of the Content Storage.

20. The non-transitory computer-readable recording medium as claimed in claim 19, wherein the method further comprising:
receiving, by the Scheduler Module, content status information from the Content Delivery Management Module; and
outputting, based on the content status information and by the Scheduler Module, a user interface (UI) to a user.
